(19) United States
(12) Patent Application Publication
(10) Pub. No.: US 2018/0208070 A1
(43) Pub. Date: Jul. 26, 2018

(54) AUTOMATED BATTERY SERVICING, INCLUDING CHARGING AND REPLACEMENT, FOR UNMANNED AERIAL VEHICLES, AND ASSOCIATED SYSTEMS AND METHODS

(71) Applicant: VTRUS, INC., Seattle, WA (US)

(72) Inventors: Carlos Rafael Sanchez, Seattle, WA (US); Jonathan David Lenoff, Seattle, WA (US); Renato Fernando Salas-Moreno, Seattle, WA (US)

(21) Appl. No.: 15/875,375

(22) Filed: Jan. 19, 2018

Related U.S. Application Data
(60) Provisional application No. 62/448,376, filed on Jan. 19, 2017.

(51) Int. Cl. B60L 11/18; G05D 1/04; B64C 39/02

(52) U.S. Cl. CPC B60L 11/1824; B60L 11/1822; B60L 11/1827; G05D 1/042; B64C 2201/141; B60L 2200/10; B64C 2201/042; B64C 2201/027; B64C 2201/108; B64C 39/024

(57) ABSTRACT

Automated battery servicing, including charging and/or replacement, for unmanned aerial vehicles, and associated systems and methods. A representative system includes a landing structure, at least one positioning element located proximate to the landing structure and movable relative to the landing structure to re-position an unmanned aerial vehicle at the landing structure, and a battery service device positioned proximate to the landing structure. The battery service device is configured to (a) charge a battery carried by the unmanned aerial vehicle at the landing structure, or (b) remove and replace the battery carried by the unmanned aerial vehicle at the landing structure, or (c) both (a) and (b).

### CROSS-REFERENCE TO RELATED APPLICATION

The present application claims priority to U.S. Provisional Application No. 62/448,376, filed on Jan. 19, 2017, and incorporated herein by reference in its entirety.

### TECHNICAL FIELD

The present technology is directed generally to automated battery servicing, including charging and/or replacement, for unmanned aerial vehicles, and associated systems and methods.

### BACKGROUND

Unmanned aerial vehicles (UAVs) have been gaining popularity in a wide variety of contexts, including for a wide variety of commercial, consumer, and military applications. In many cases, the UAVs are powered by electric motors, which are in turn powered by batteries. One long-standing problem with battery-propelled UAVs, is the generally short amount of time the UAV is able to remain in flight, due to limited charge carried by the battery. This problem can be particularly significant for multi-copter UAVs, which have become increasingly prevalent, and which generally have higher power consumption rates than do fixed wing aircraft. Additionally, exchanging or charging batteries is typically an activity that requires human intervention, which can significantly reduce autonomous or other capabilities of the UAV. As a result, the use of UAVs in challenging or potentially dangerous environments may typically require a human to be present, which is contrary to the notion of using UAVs to avoid the need for a human in such environments. Accordingly, there remains a need for addressing limited battery life, the associated limited UAV flight time that result, and the dependence on a human operator

### BRIEF DESCRIPTION OF THE DRAWINGS

FIG. 1 is a partially schematic, isometric illustration of a representative UAV configured for automated battery charging and/or battery replacement, in accordance with embodiments of the present technology.

FIG. 2 is a partially schematic, isometric illustration of a battery configured to be recharged and replaced, in accordance with embodiments of the present technology.

FIG. 3 is a partially schematic, isometric illustration of a system for recharging and replacing UAV batteries in accordance with embodiments of the present technology.

FIG. 4 is a flow diagram illustrating a process for charging batteries onboard a UAV in accordance with embodiments of the present technology.

FIGS. 5A-5C illustrate a representative system during selected phases of a battery recharging operation, in accordance with embodiments of the present technology.

FIG. 6 is a flow diagram illustrating a process for removing and replacing a UAV battery in accordance with embodiments of the present technology.

FIGS. 7A-7F illustrate a representative system during selected phases of a battery removal and replacement operation, in accordance with embodiments of the present technology.

FIG. 8 is a partially schematic, plan view illustration of a UAV and battery servicing system configured to service batteries of the UAV, configured in accordance with some embodiments of the present technology.

FIG. 9 is a partially schematic, isometric illustration of UAV having another configuration suitable for battery recharging and removal/replacement operations, in accordance with embodiments of the present technology.

### DETAILED DESCRIPTION

The present technology is directed generally to automated battery servicing techniques, including recharging and/or replacing batteries for unmanned aerial vehicles, and associated systems and methods. In some embodiments, a representative battery servicing system can be used to (a) recharge batteries while the batteries remain onboard the UAV, and/or (b) remove and replace batteries from the same or a different UAV, all in an automated, or semi-automated manner. Accordingly, the amount of time required for the UAV to obtain additional power, after an initial battery charge has been depleted, can be significantly reduced. In addition, the automated approach can significantly reduce the amount of human involvement required to provide the UAV with additional power. As a result, the operations carried out by the UAV can be more efficient, repeatable, and/or reliable, than are current conventional techniques. Because a single system can be used to both recharge a battery onboard the UAV, and replace a UAV battery, the amount of ground-based equipment required to service the UAV can be consolidated and/or reduced.

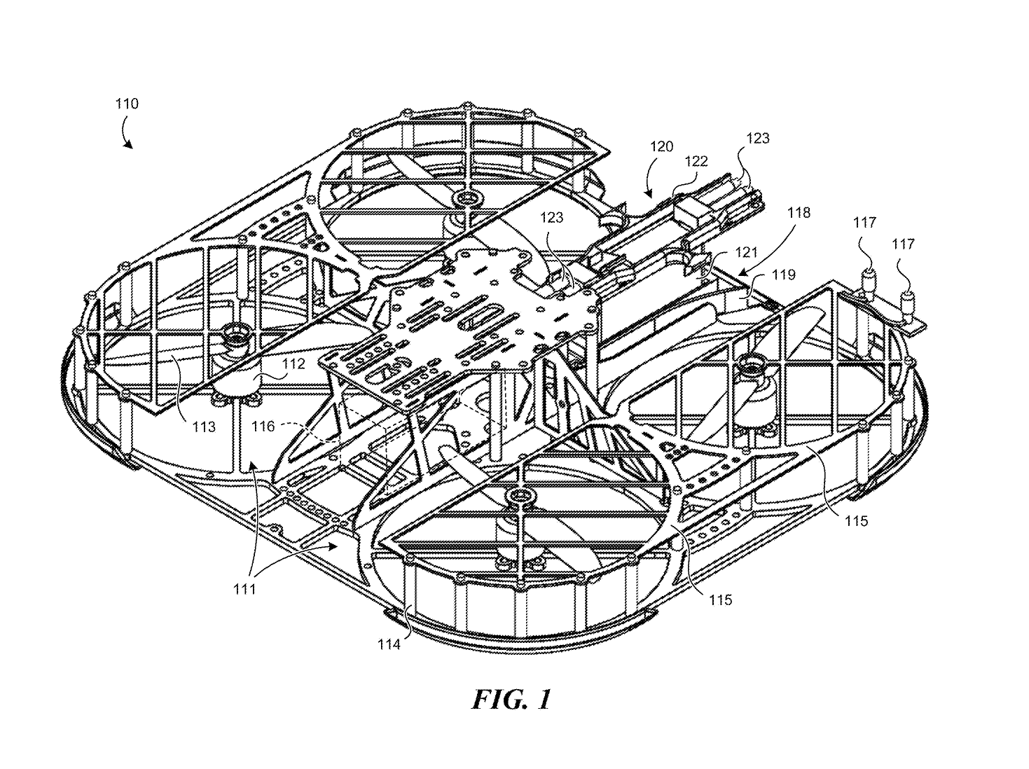

Specific details of several embodiments of the present technology are described below with reference to representative UAVs and battery servicing devices, to provide a thorough understanding of these embodiments. In other embodiments, the UAVs and/or battery servicing devices can have other configurations. Several details describing structures or processes that are well-known and often associated with UAVs and associated devices, but that may unnecessarily obscure some significant aspects of the present disclosure, are not set forth in the following description for purposes of clarity. Moreover, although the following disclosure sets forth several embodiments of different aspects of the present technology, several other embodiments can have different configurations, and/or different components than those described herein. Accordingly, the present technology may have other embodiments with additional elements, and/or without several of the elements described below with reference to FIGS. 1-9.

Some embodiments of the disclosed technology may take the form of computer-executable instructions, including routines executed by a programmable computer or controller. Those skilled in the relevant art will appreciate that the technology can be practiced on computer or controller systems other than those shown and described herein. The technology can be embodied in a special-purpose computer, controller, or data processor that is specifically programmed, configured, or constructed to perform one or more of the computer-executable instructions described below. Accordingly, the terms “computer” and “controller” as generally used herein include a suitable data processor and can include internet appliances and hand-held devices, including palm-top computers, wearable computers, cellular or mobile phones, multi-processor systems, processor-based programmable consumer electronics, network computers, laptop computers, mini-computers, and the like. Information handled by these computers can be presented at any suitable display medium, including a liquid crystal display (LCD) and/or a touchscreen. As is known in the art, these computers and controllers commonly have various processors, memories (e.g., non-transitory computer-readable media), input/output devices, and/or other suitable features.

The present technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the present technology are also encompassed within some embodiments of the present technology.

FIG. 1 is a partially schematic, isometric illustration of an unmanned aerial vehicle (UAV) 110 configured to undergo a battery recharging operation and/or a battery replacement operation in accordance with embodiments of the present technology. The UAV 110 can include a body 114 carrying a propulsion system 111 and an onboard controller 116 (shown schematically in dashed lines). The propulsion system 111 can include a plurality of propellers 113 driven by one or more corresponding motors 112, which are in turn powered by one or more batteries 120. The UAV 110 can include other features, for example, shrouds 115 that enclose or partially enclose the propellers 113, sensors, navigation aids, communication devices, and/or any of a variety of suitable payloads, that are not shown in FIG. 1 for purposes of clarity, but that may be used to facilitate the UAV carrying out a mission. Suitable missions, including mapping and other operations, are described in pending U.S. application Ser. No. ______, titled “Indoor Mapping and Modular Control for UAVs and Other Autonomous Vehicles, and Associated Systems and Methods,” filed concurrently herewith, and incorporated herein by reference.

The battery 120 can include one or more battery cells 121, for example, lithium ion cells or other suitable cells that facilitate a chemical reaction to produce electrical current. The battery 120 can further include an interface device 122 that provides an electrical interface with the UAV 110 and/or with a servicing device, as described in further detail later. For example, the interface 122 can carry multiple battery contacts 123 that can be removably engaged with corresponding contacts (not visible in FIG. 1) carried by the UAV 110 to transmit power from the battery cells 121 to the motors 112, onboard controller 116, and/or other power-consuming elements of the UAV 110. The interface device 122 can also include elements that facilitate removing and replacing the battery 120, as will be described in further detail below.

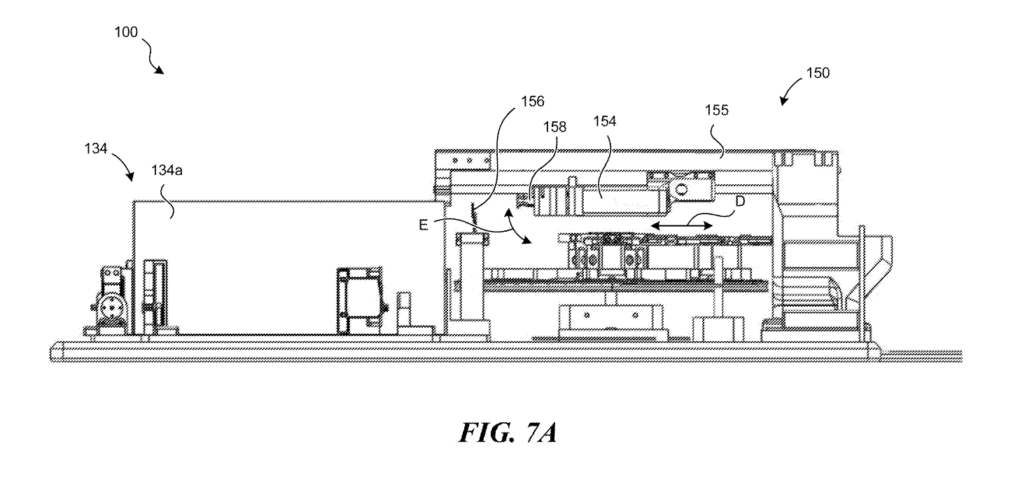

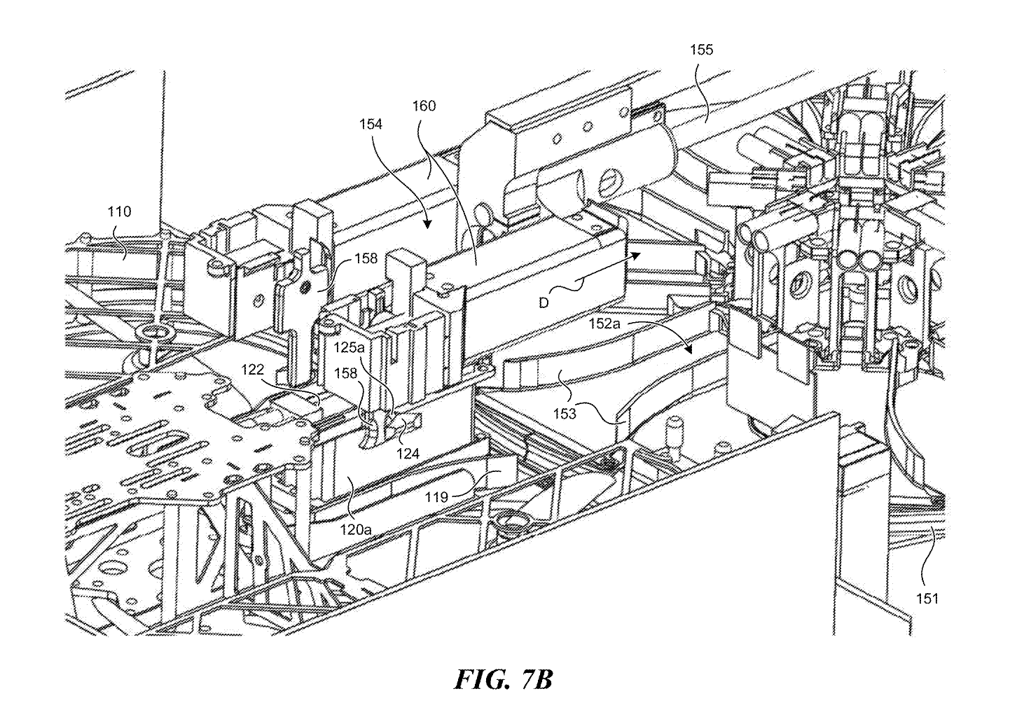

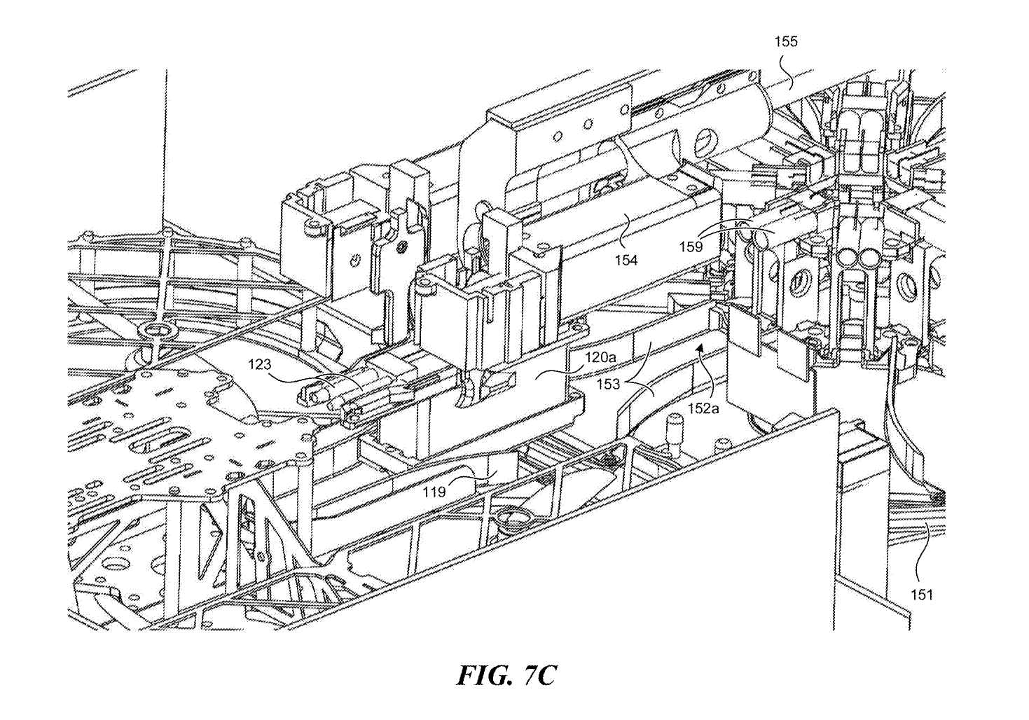

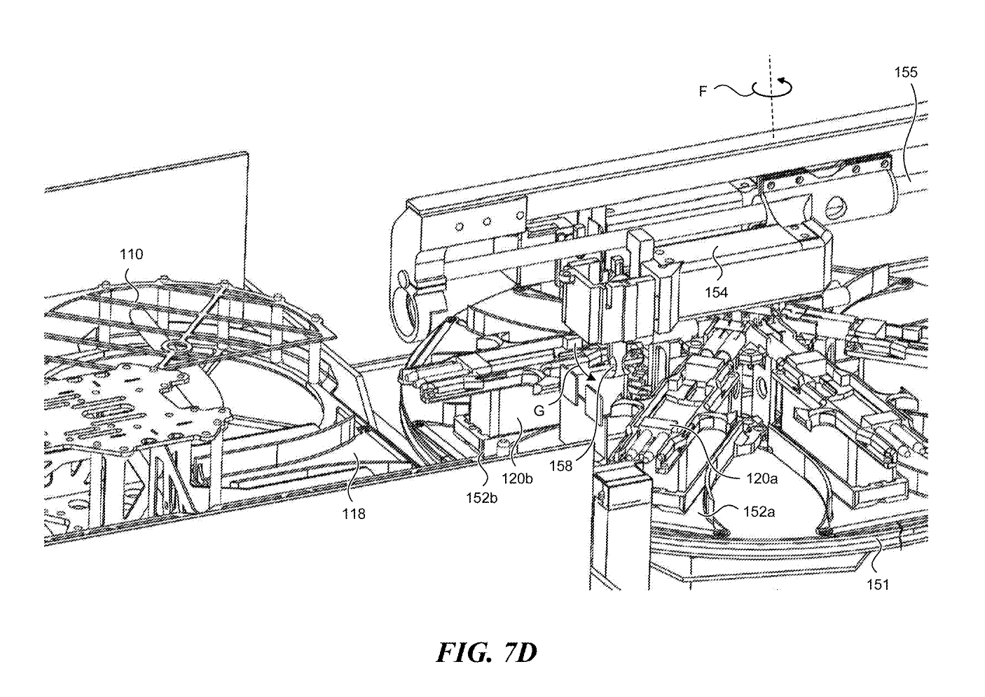

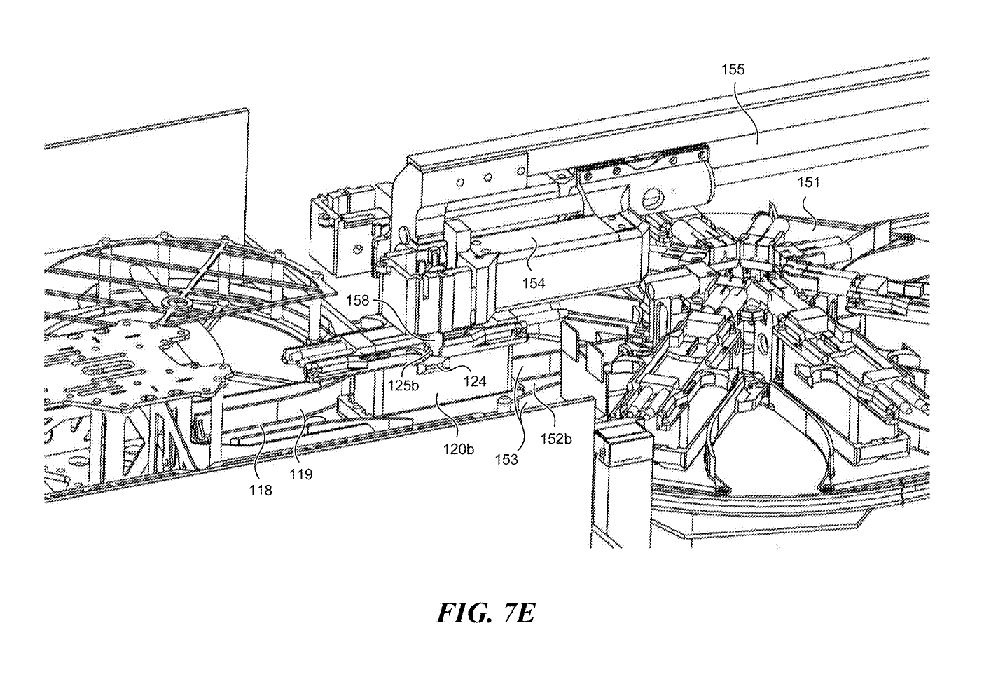

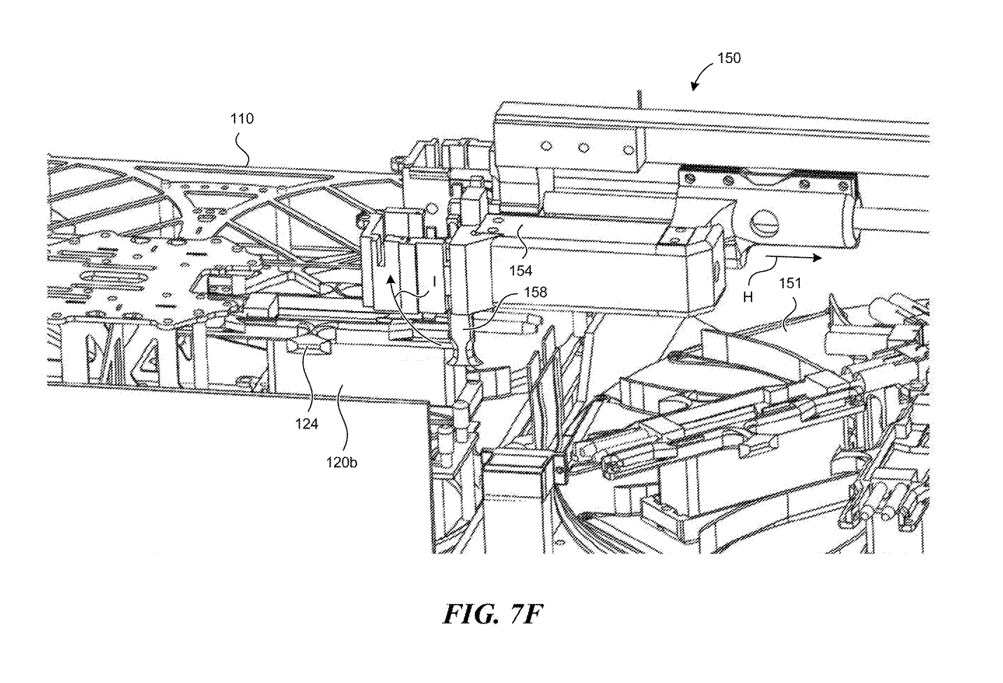

The UAV 110 can include recharge contacts 117 that are used to recharge the battery 120 while the battery remains onboard the UAV 110. In an embodiment shown in FIG. 1, the recharge contacts 117 are carried by the body 114 of the UAV 110. In other embodiments, the recharge contacts 117 can be carried by the battery 120 and/or other elements of the UAV 110. In any of these embodiments, the battery 120 can be positioned in a battery bay 118 that is particularly sized, shaped, and positioned to house the battery 120 and to allow the battery 120 to be easily removed and replaced. For example, the battery bay 118 can be bounded by, or can otherwise include, first battery guides 119 that constrain the motion of the battery 120 to a linear path, as it is removed from and loaded into the battery bay 118. Further details are described later with reference to FIGS. 7A-7F.

In addition to recharging the battery 120, the recharge contacts 117 can be used to supply power to the UAV 110, e.g., directly to one or more systems of the UAV 110. For example, the recharge contacts 117 can provide continuous power to some or all of the powered UAV systems/subsystems, even as the battery 120 is removed and replaced. Accordingly, the UAV 110 can undergo a battery removal/replacement operation without interrupting power to the UAV systems/subsystems, which saves time by avoiding a typical power-down/restart sequence. As a result, the UAV 110 may use the recharge contacts 117 even if the battery 120 is not being charged onboard.

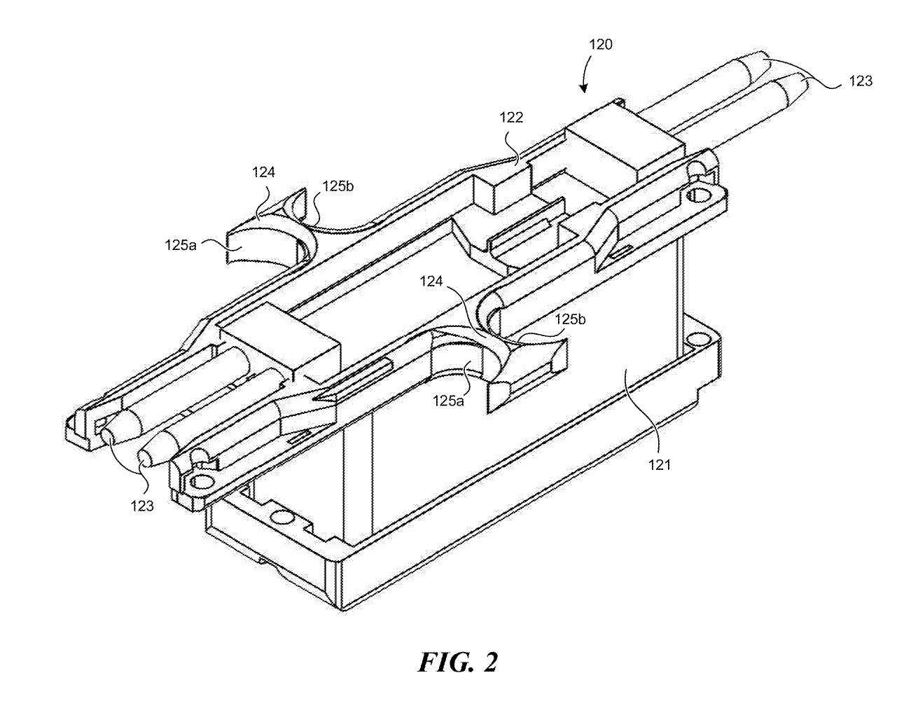

FIG. 2 is a partially schematic, isometric illustration of a representative battery 120, illustrating further selected features of the interface device 122. For example, the interface device 122 can include one or more battery engaging elements 124 (two are shown in FIG. 2) that interface with a corresponding battery service device. Each battery engaging element 124 can include a first surface 125a and a second, oppositely facing surface 125b. As will be discussed later, the first and second surfaces 125a, 125b can facilitate pulling the battery out of the battery bay 118 (FIG. 1) and pushing a new battery into the battery bay 118. The interface device 122 can include two oppositely facing pairs of battery contacts 123, so that the battery 120 can be connect to the UAV 110 and/or a battery service device in either of two orientations.

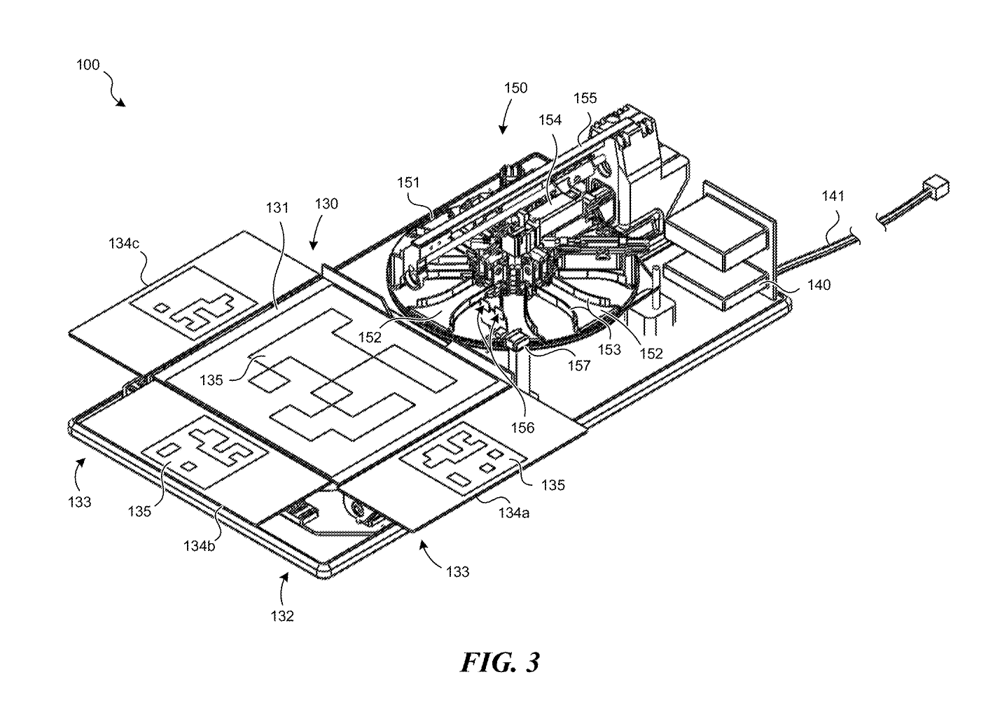

FIG. 3 is a partially schematic, isometric illustration of an overall system 100 configured to recharge one or more batteries of the UAV 110 described above with reference to FIG. 1. Accordingly, the system 100 can include a landing structure 130 configured to support the UAV as it is being serviced, and a battery service device 150 that executes the servicing steps. Each is discussed in turn below.

The landing structure 130 can include a landing platform 131, e.g., a generally flat surface suitable for landing any of a variety of correspondingly suitable UAVs. The landing structure 130 can further include a UAV positioning device 132 that orients the UAV prior to servicing. Accordingly, the UAV positioning device 132 can include one or more positioning elements 133. Representative positioning elements 133 include flaps 134, illustrated as first, second, and third flaps 134a,134b, 134c. Each of the flaps 134 can be pivotable (or otherwise movable) relative to the landing platform 131 to urge the UAV into a position suitable for servicing. Any of the positioning elements 133 and/or the landing platform 131 can include identifiers 135 that are used to help position the UAV in, or at least close to, the position it should be in for servicing. For example, the identifiers 135 can include black and white visual markings that can be readily recognized by a visual sensor aboard the UAV and used to orient and/or position the UAV just prior to landing. In other embodiments, the identifiers 135 can include other features, for example, features that are not visible to the human eye.

The battery service device 150 can include one or more charging contacts 156 coupled to an actuator 157. The charging contacts 156 can be moved between the disengaged position (shown in FIG. 3) and an engaged position in which the charging contacts 156 releasably connect to the recharge contacts 117 of the UAV 110 (FIG. 1).

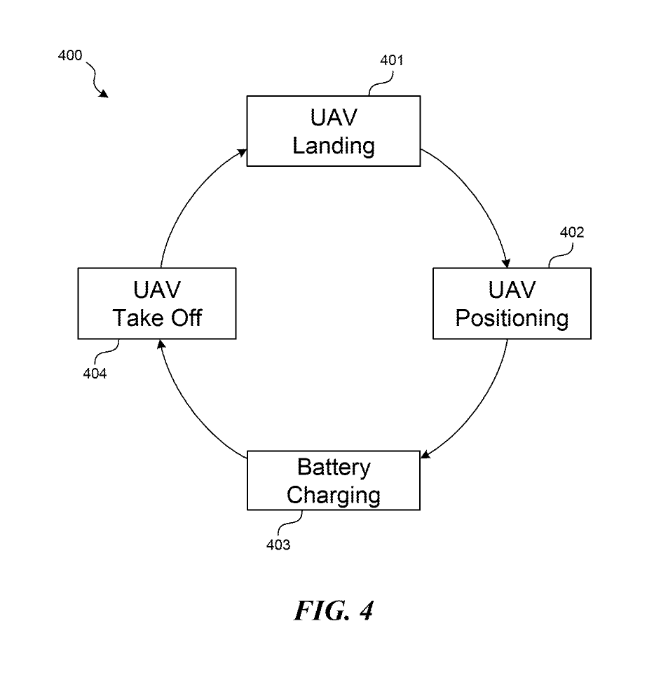

As described above, the charging contacts 156 can be used to recharge a battery while the battery remains aboard the UAV 110 (FIG. 1), and/or provide power to the UAV 110 independent of charging the battery. The battery service device 150 can also remove the battery from the UAV and replace it with a freshly charged battery. Accordingly, the battery service device 150 can include a battery carrier 154 that removes batteries (e.g., depleted, partially depleted and/or deficient batteries) from the UAV and replaces the removed batteries with fresh batteries. In some embodiments, the battery carrier 154 moves in linear fashion along a carrier guide 155 to perform both the removal and replacement operations. Accordingly, at least a portion of the guide 155 is linear. New batteries can be stored at multiple stations 152 of a carousel 151 or other repository. The carousel 151 can include second battery guides 153 to guide the batteries into and out of the stations 152. Accordingly, the stations 152 can also be used to receive batteries that are removed from the UAV, and such batteries can be recharged at the carousel 151. These operations will be described further below with reference to FIGS. 4-8F.

Some or all of the operations described herein may be carried out autonomously or semi-autonomously by a controller 140. Accordingly, the controller 140 can be coupled to the positioning elements 133, the charging contacts 156, the battery carrier 154, and the carousel 151. Power and communications are provided to the battery service device (for the controller 140, actuators, and to supply charging currents) via one or more cables 141. In some instances (e.g., in a semi-autonomous operation mode), an operator or other user initiates certain tasks, which the controller 140 then carries out without further input by the operator. In other embodiments, the operation of charging and/or removing and replacing the batteries can be performed completely autonomously, from the point at which the UAV lands at the landing structure 130, to the point at which the UAV departs from the landing structure 130 with additional power onboard.

FIG. 4 is a flow diagram illustrating a process 400 for recharging a battery onboard a UAV. At block 401, the UAV is landed (e.g., at the landing platform 131 shown at FIG. 3) and at block 402, the UAV is positioned (e.g., via the UAV positioning device 132 shown at FIG. 3). At block 403, an onboard battery is charged by the battery service device 150 while the battery remains onboard the UAV, and at block 404, the UAV takes off (e.g., from the landing platform 131).

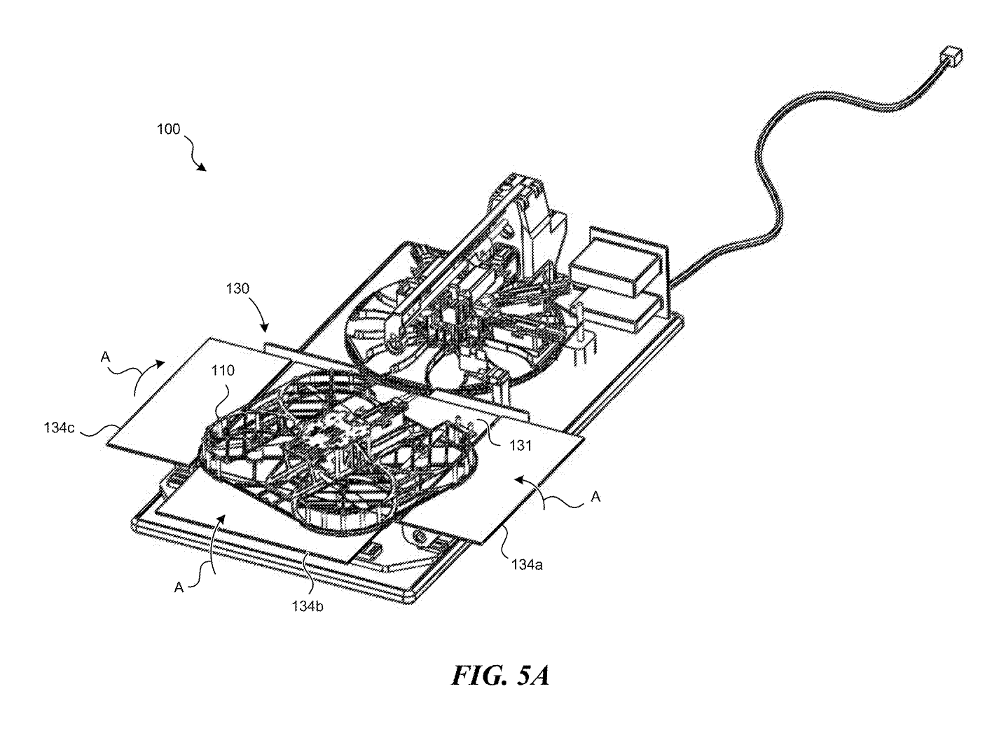

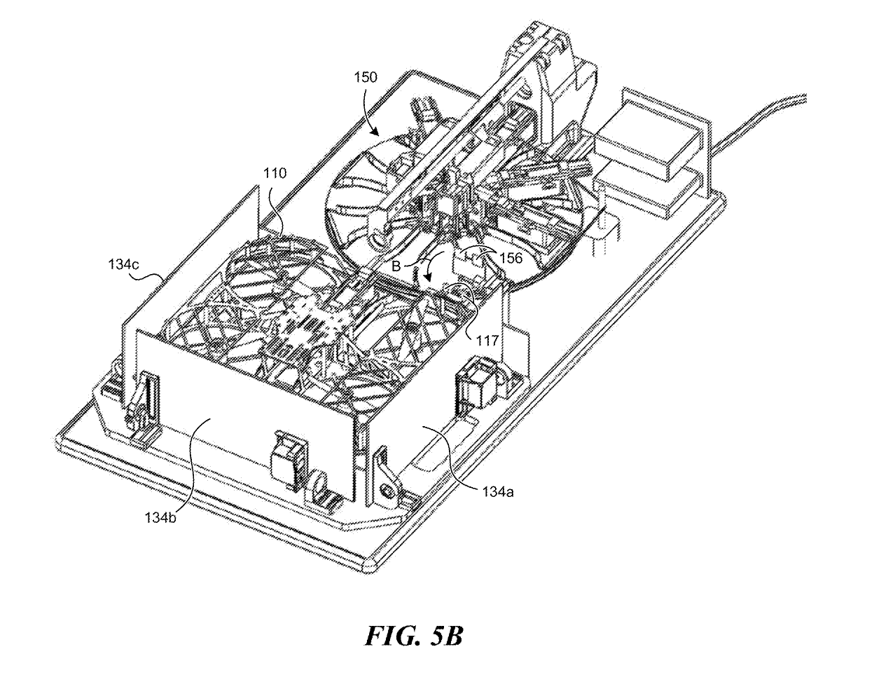

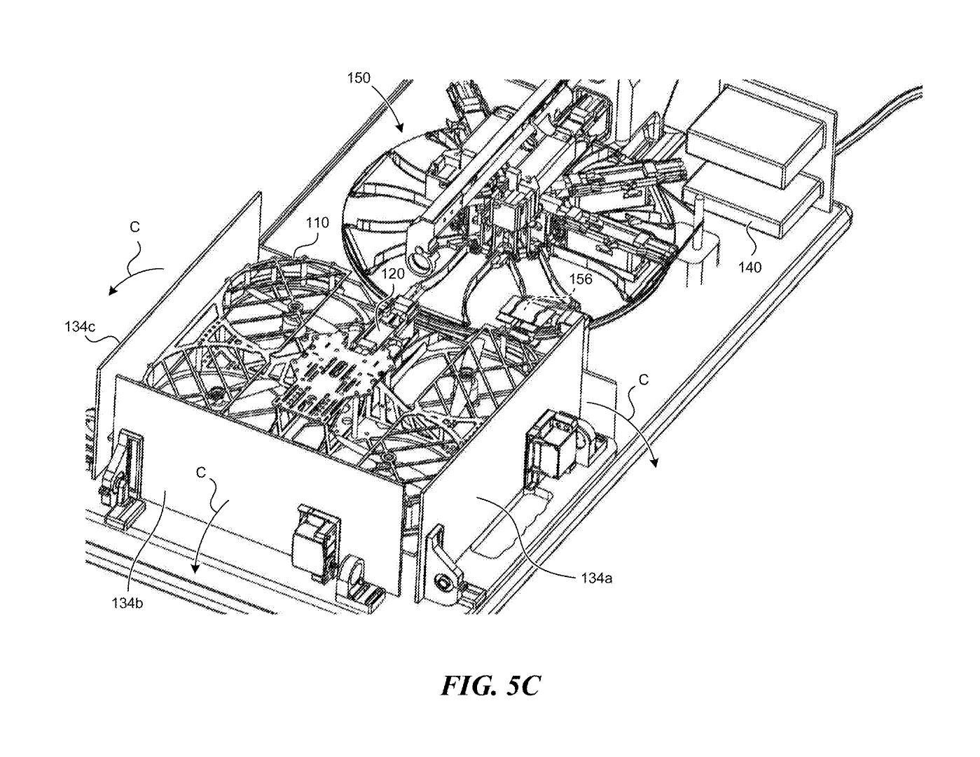

FIG. 5A illustrates the system 100 after the UAV 110 has landed at the landing structure 130. In this embodiment, the UAV 110 is primarily supported by the landing platform 131, but may extend outside the bounds of the landing platform 131 and over the flaps 134a-134c. The flaps 134a-134c can then be actuated, serially or in parallel, as indicated by arrows A to move from a neutral (e.g., horizontal, or downward position) to an active (e.g., upward position) to orient and reposition the UAV 110. Accordingly, the surfaces of the flaps 134a-134c can include a low-friction material, such as Teflon®, that allows the flaps to move the UAV 110 with a relatively low amount of force This low friction surface promotes sliding between the UAV 110 and the flaps' surface. This sliding motion helps to position the UAV 110 in proper location within the landing structure 130 and the system 100 as a whole.

In FIG. 5B, the flaps 134a-134c have been fully deflected and have accordingly positioned the UAV 110 relative to the battery service device 150 so that elements of the UAV 110 are aligned with corresponding elements of the battery service device 150. In particular, the recharge contacts 117 carried by the UAV 110 are aligned with the corresponding charging contacts 156 carried by the battery service device 150. As shown in FIG. 5B, the charging contacts 156 are in an upright, open, disengaged position. The charging contacts 156 can be rotated downwardly, as indicated by arrow B, to engage with the corresponding recharge contacts 117 to carry out a recharge operation.

FIG. 5C illustrates the battery service device 150 after the charging contacts 156 have been rotated downwardly to engage with the corresponding recharge contacts 117 (not visible in FIG. 5C) of the UAV 110. Because the charging contacts 156 apply a downward force on the recharge contacts 117, the likelihood for inadvertently moving the UAV 110 is significantly reduced, and is further reduced by the presence of the flaps 134a-134c. The fact that the UAV is precisely located by the flaps 134a-134c means that the charging contacts 156 and recharge contacts 117 can be relatively small. Because these contacts can be small they may also allow for high contact pressures which help to facilitate high current transfer safely.

The controller 140 initiates a charging operation to recharge the battery 120 onboard the UAV 110. After the battery 120 has been suitably recharged, the charging contacts 156 are rotated away from the recharge contacts 117, the flaps 134a-134c are rotated downwardly away from the UAV 110 (as indicated by arrows C) and the UAV is free to take off and carry out additional missions.

In some embodiments, the charging contacts 156 can be supplemented with data contacts that engage with a corresponding data port carried by the UAV 110. Accordingly, the UAV 110 can download and/or upload data while at the battery service device 150, e.g., as the battery 120 is being charged.

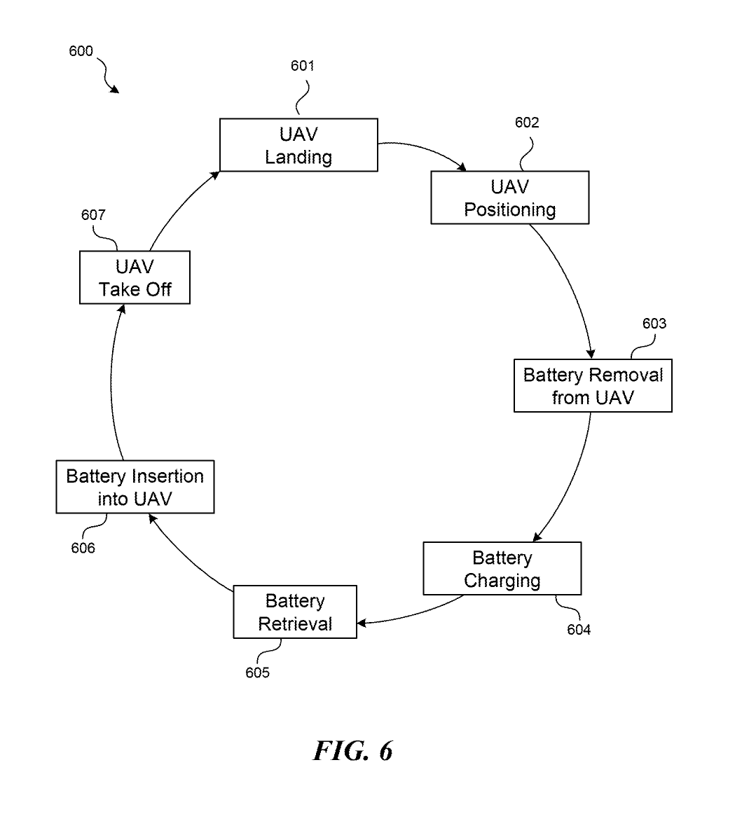

FIG. 6 is a flow diagram illustrating a process 600 for removing and replacing UAV batteries. The process can include landing the UAV (block 601), positioning the UAV (block 602) and removing a first battery from the UAV (block 603). The process can further include charging a second battery (block 604), which may be conducted prior to landing the UAV (block 601). At block 605, the second battery is retrieved, and at block 606, the second battery is loaded onto (e.g., inserted into) the UAV. The UAV then takes off from the battery servicing device to complete additional missions (block 607).

FIGS. 7A-7F illustrates the system 100 undergoing a process having elements corresponding to those of FIG. 6. FIG. 7A is a partially schematic, side elevational view of the system 100 illustrating the flaps 134 (of which the first flap 134a is visible) in the upright position to appropriately locate the UAV (positioned behind the first flap 134a) for battery servicing. The charging contacts 156 described above are shown in the disengaged position. Throughout the sequence shown in FIG. 7A-7F, the charging contacts 156 may be deployed, as discussed above, to maintain uninterrupted power to the UAV systems while the battery carrier 154 operates to remove and replace the battery aboard the UAV. To do so, the battery carrier 154 can move back and forth along the carrier guide 155, as indicated by arrow D. In addition, one or more (e.g., a pair of) battery engaging arms 158 can rotate upwardly and downwardly, as indicated by arrow E to engage with and move both a first battery (that is removed from the UAV) and a second battery (that is added to the UAV).

FIG. 7B illustrates the UAV 110 in position to have a first battery 120a removed. As shown in FIG. 7B, the battery carrier 154 includes two projections 160, each carrying one engaging arm 158. The battery carrier 154 has moved along the carrier guide 155 to be positioned over the first battery 120a, and the battery engaging arms 158 have swung down to engage with the interface device 122 of the first battery 120a. In particular, the battery engaging arms 158 have swung downwardly to engage with the forward facing first surfaces 125a of the battery engaging elements 124. In this configuration, the battery carrier 154 can be moved to the right, as indicated by arrow D to disengage (e.g., pull) the first battery 120a from the UAV 110. The battery carrier 154 and the first battery move as a unit, and the first battery 120a enters a first station 152a of the carousel 151. The battery engaging arms 158 can be locked in the engaged position (e.g., via a servo) to reduce torque loads on the actuator that swings the arms into position, as a horizontal force is applied to the arms during the linear motion.

FIG. 7C illustrates the battery carrier 154 after it has disengaged the first battery 120a from the UAV 110, and has begun to move it into the first battery bay 152a. The first battery guides 119 guide the motion of the first battery 120a as it exits the UAV 110, and the second battery guides 153 guide the first battery 120a as it enter the first station 152a. Forward facing battery contacts 123, which were previously connected to the UAV 110, are now exposed and visible. Rearward facing contacts (not visible in FIG. 7C can mate with corresponding contacts 159 carried by the carousel 151 so as to be recharged on the carousel 151.

In FIG. 7D, the first battery 120a has been securely positioned in the first station 152a, and the carousel 151 has rotated counter-clockwise, as indicated by arrow F to align a second station 152b with the battery bay 118 of the UAV 110. A second battery 120b (e.g., fully charged) is positioned in the second station 152b. The carrier 154 is now positioned behind the second battery 120b, and the battery engaging arms 158 have been rotated downwardly, as indicated by arrow G so as to push the second battery 120b toward the battery bay 118 of the UAV.

In FIG. 7E, the battery carrier 154 has now moved to engage the second battery 120b. More specifically, the battery engaging arms 158 have contacted corresponding rearwardly facing second surfaces 125b of the battery engaging elements 124, and the battery carrier 154 has begun moving the second battery 120b out of the second station 152b and into the battery bay 118. Again, the second battery guides 153 guide the motion of the second battery 120b out of the carousel 151, and the first battery guides 119 guide the motion of the second battery 120b into the UAV battery bay 118.

In FIG. 7F, the battery carrier 154 has successfully engaged the second battery 120b with the corresponding electrical contacts carried by the UAV 110, and has backed away from the second battery 120b, as indicated by arrow H. In this position, the battery engaging arms 158 may be swung upwardly, as indicated by arrow I so as to clear any elements of the UAV 110 and/or the battery service device 150 as the battery carrier 154 moves back into position over the carousel 151. The UAV 110 can then take off, and the battery service device 150 can be prepared for the next operation. Representative next operations can include recharging an onboard battery, as discussed above with reference to FIGS. 5A-C, and/or recharging a discharged battery received from the UAV 110 (at the battery service device 150), and/or rotating the carousel 151 to position an open station to receive a removed battery from the same or a different UAV. The system 100 can recharge several batteries at once at the battery service device, to further improve system efficiency.

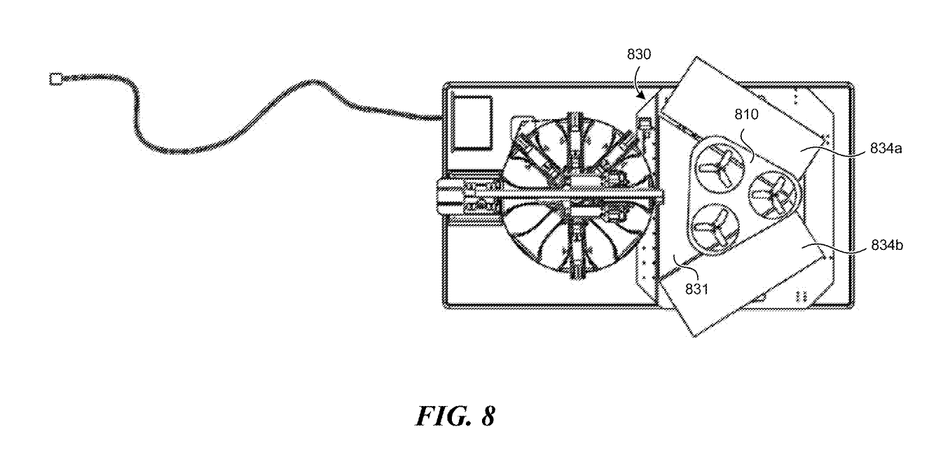

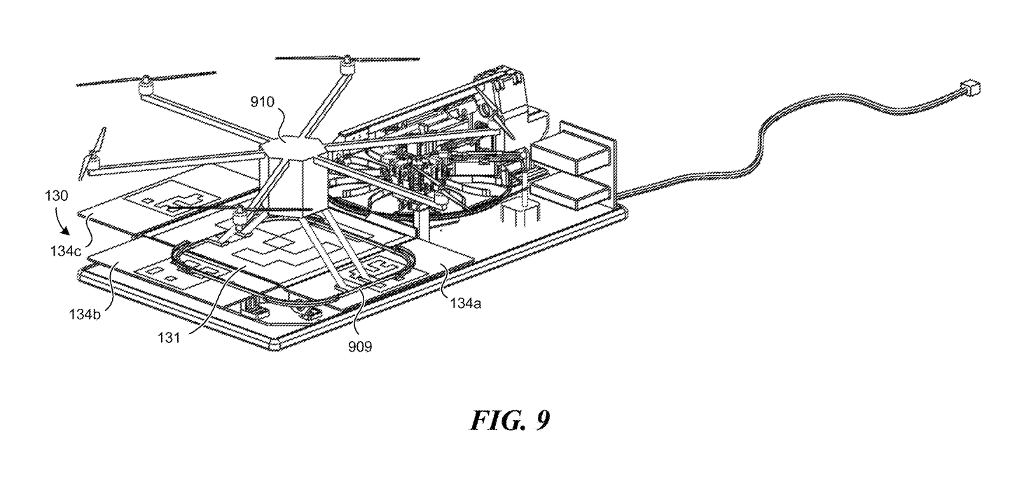

As shown in FIGS. 8 and 9, the UAVs served by the battery service device 150 can have configurations other than those specifically described above with reference to FIGS. 1-7F. For example, referring now to FIG. 8, a representative UAV 810 can have a generally triangular configuration, and the corresponding landing structure 830 can be configured to account for this different shape. In particular, the landing structure 830 can include a triangular-shaped landing platform 831. The positioning flaps 834a, 834b (which may number no more than two in at least some embodiments are located and movable to engage with the triangular-shaped UAV 810 for positioning, e.g., in generally the same manner as discussed above with reference to FIGS. 5A-5B. In this case, the positioning flaps are oriented at non-orthogonal angles relative to each other, unlike the configuration shown in FIG. 5A. Other aspects of the operations described above with reference to FIGS. 1-7F can be generally similar.

As shown in FIG. 9, another representative UAV 910 can include one or more landing skids 909 rather than a generally flat-sided body 114, as shown in FIG. 1. The landing structure 130 can operate with this UAV as well, in generally the same manner as described above with reference to FIGS. 5A-5B. In this particular instance, the low-friction contact between the flaps 134 and the landing skids 909 can be particularly beneficial so that as the flaps 134 rotate upwardly, the UAV 910 does not tip over.

One feature of at least some of the embodiments described herein is that the disclosed systems and associated methods can facilitate charging a UAV autonomously or semi autonomously. An advantage of this arrangement is that it can reduce the time and operator effort required to recharge or otherwise re-power the UAV. Accordingly, the overall efficiency of operating the UAV can be significantly improved. As disclosed herein, one approach for recharging the UAV is to recharge the battery while the battery remains aboard the UAV. Another approach includes removing a discharged or partially discharged battery from the UAV and replacing it with a charged or more fully charged battery. In at least some embodiments, both operations can be completed by a single device, which can further improve overall system efficiency.

Another feature of some of the embodiments disclosed herein is that the motion paths for performing the foregoing operation can be simple. This approach reduces mechanical complexity and the likelihood for failure during operation, and can improve system repeatability and reliability. For example, the recharge contacts can undergo a simple pivoting motion to cycle between engaged and disengaged positions. The battery carrier can move along a simple linear path to both load and unload batteries, and the battery engaging arms can rotate between just two positions for both loading and unloading.

Another feature of some of the embodiments disclosed herein is that the relatively simple mechanisms can allow the device to be readily scaled or otherwise adjusted to accommodate UAVs of different sizes and/or shapes. For example, representative UAVs having different shapes were described above with reference to FIGS. 8 and 9. The UAVs can also be larger or smaller than those shown in the Figures, while the general layout and operation of the system can remain the same or approximately the same.

From the foregoing, it will be appreciated that specific embodiments of the present technology have been described herein for purposes of illustration, but that various modifications may be made without deviating from the present technology. For example, the systems and devices illustrated herein may have configurations other than those specifically shown. The unmanned vehicles amenable to being recharged via the systems and methods disclosed herein can have configurations other than those specifically shown and described herein. The devices used to position the unmanned vehicles for servicing, and/or the devices that recharge the onboard UAV battery, and/or the devices that remove and replace the UAV battery can have configurations other than those described herein. For example, the carrier guide can motion paths in addition to or in lieu of the linear motion path described above. In some embodiments, the general approach described above with reference to battery removal and replacement can be applied to other loads carried by the UAV, for example, cargo and/or other payloads. The various contacts described above can have a variety of suitable configurations, including simple surface-to-surface interfaces and/or male-female interfaces. In any of these embodiments, the electrical connection I secure, robust, and low resistance, so as to avoid losses and heating.

Certain aspects of the technology described in the context of particular embodiments may be combined or eliminated in other embodiments. For example, in some embodiments, the recharging device may be configured to perform only a recharging operation, or only a remove and replace operation, or both an onboard recharging operation and a remove and replace operation. While a device that can perform both operations can be particularly advantageous, single operation devices also have utility. Further, while advantages associated with certain embodiments of the technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

As used herein, the phrase “and/or,” as in “A and/or B” includes A alone, B alone, and both A and B. To the extent that any materials incorporated herein by reference conflict with the present disclosure, the present disclosure controls.

I/We claim:

1. An unmanned aerial vehicle charging system, comprising:
a landing structure;
at least one positioning element located proximate to the landing structure and movable relative to the landing structure to re-position an unmanned aerial vehicle at the landing structure; and
a battery service device positioned proximate to the landing structure and configured to:
(a) charge a battery carried by the unmanned aerial vehicle at the landing structure; or
(b) remove and replace the battery carried by the unmanned aerial vehicle at the landing structure; or
(c) both (a) and (b).

2. The system of claim 1, further comprising a controller operatively coupled to the at least one positioning element and the battery servicing device, the controller being programmed with instructions for both charging and replacing the battery, wherein the instructions, when executed:
autonomously direct motion of the at least one positioning element to re-position the unmanned aerial vehicle; and perform at least one of the following tasks:
autonomously direct the battery servicing device to perform a battery charging operation;
autonomously direct the battery servicing device to perform a battery remove and replace operation.

3. The system of claim 1, further comprising the unmanned aerial vehicle.

4. The system of claim 1 wherein the landing structure includes a generally flat platform.

5. The system of claim 1 wherein at the landing structure and/or the at least one positioning element includes an identifier, detectable by the unmanned aerial vehicle, to orient the unmanned aerial vehicle relative to the landing structure and/or the at least one positioning element.

6. The system of claim 1 wherein the at least one positioning element includes a flap that is pivotable relative to the landing structure between a neutral position and an active position to re-position the unmanned aerial vehicle at the landing structure.

7. The system of claim 6 wherein the flap is one of three flaps, each pivotable relative to the landing structure between a neutral position and an active position.

8. The system of claim 7 wherein at least two of the flaps are orthogonal to each other.

9. The system of claim 6 wherein the flap is one of only two flaps movable relative to the landing structure to re-position the unmanned aerial vehicle at the landing structure.

10. The system of claim 1 wherein the battery servicing device includes at least one charging contact movable between a first position in which the charging contact is disengaged from a corresponding power contact of the unmanned aerial vehicle, and a second position in which the charging contact is engaged with the corresponding power contact of the unmanned aerial vehicle.

11. The system of claim 1 wherein the battery servicing device includes a carousel positioned to carry charged and uncharged batteries.

12. The system of claim 1 wherein the battery servicing device includes:
a guide;
a battery carrier movable along the guide between a first position in which the battery carrier is disengaged from a battery carried by the unmanned aerial vehicle, and a second position in which the battery carrier is engaged with the battery carried by the unmanned aerial vehicle.

13. The system of claim 12 wherein the guide includes a linear guide portion.

14. The system of claim 12 wherein the battery carrier includes at least one arm pivotable between a first position for engaging with the battery, and a second position for disengaging from the battery.

15. The system of claim 14, further comprising the battery, and wherein the battery includes a battery engaging element having a first surface positioned to be engaged by the at least one arm in a pulling configuration, and a second surface, facing opposite from the first surface to be engaged by the at least one arm in a pushing configuration.

16. An unmanned aerial vehicle charging system, comprising:
a generally flat landing structure;
a battery positioning device that includes a plurality of flaps hingedly coupled to the landing structure and movable relative to the landing structure between a neutral position and an active position to re-position an unmanned aerial vehicle at the landing structure; and
a battery servicing device positioned proximate to the landing structure, the battery servicing device having:
at least two charging contacts, both movable between a first position in which the charging contact is disengaged from a corresponding power contact of the unmanned aerial vehicle, and a second position in which the charging contact is engaged with the corresponding power contact of the unmanned aerial vehicle;
a guide;
a carousel positioned beneath the guide, the carousel having a plurality of battery stations and being rotatable relative to the guide to align an individual battery station with the guide;
a battery carrier movable along the guide between a first position in which the battery carrier is disengaged from a first battery carried by the unmanned aerial vehicle, a second position in which the battery carrier is engaged with the first battery carried by the unmanned aerial vehicle, and a third position in which the battery carrier is engaged with a second battery carried by the carousel; and
a controller operatively coupled to the battery positioning device and the battery servicing device, the controller being programmed with instructions for both charging and replacing a battery, wherein the instructions, when executed:
(a) autonomously direct motion of the flaps to re-position the unmanned aerial vehicle; and perform one or both of the following tasks:
(b) autonomously direct the at least two charging contacts to engage with corresponding contacts carried by the unmanned aerial vehicle;
(c) autonomously direct the battery carrier to remove a first battery carried by the unmanned aerial vehicle and replace the first battery with a second battery carried by the carousel.

17. The system of claim 16, further comprising the unmanned aerial vehicle.

18. A computer-implemented method for supplying power to an unmanned aerial vehicle, the method comprising:
re-positioning the unmanned aerial vehicle at a landing structure; and
(a) autonomously charging a battery carried by the unmanned aerial vehicle while the unmanned aerial vehicle is positioned at the landing structure; or
(b) autonomously removing and replacing the battery carried by the unmanned aerial vehicle at the landing structure while the unmanned aerial vehicle is positioned at the landing structure; or
(c) both (a) and (b).

19. The method of claim 18, further comprising conducting a process onboard the unmanned aerial vehicle, the process including:
detecting an identifier corresponding to an orientation of the unmanned aerial vehicle relative to the landing structure; and
in response to detecting the identifier, adjusting a position and/or an orientation of the unmanned aerial vehicle relative to the landing structure.

20. The method of claim 18 wherein repositioning the unmanned aerial vehicle includes moving one or more flaps relative to the landing structure to engage and move the unmanned aerial vehicle.

21. The method of claim 18 wherein charging the battery carried by the unmanned aerial vehicle includes moving at least one charging contact between a first position in which the charging contact is disengaged from a corresponding contact of the unmanned aerial vehicle to a second position in which the charging contact is engaged with the corresponding contact of the unmanned aerial vehicle.

22. The method of claim 18 wherein the battery is a first battery, and wherein removing and replacing includes:
engaging a battery carrier with the first battery while the unmanned aerial vehicle is at the landing structure;
removing the first battery from the unmanned aerial vehicle by moving the battery carrier and the first battery as a unit away from the unmanned aerial vehicle;
releasing the first battery from the battery carrier;
engaging the battery carrier with a second battery;
moving the battery carrier and the second battery as a unit toward the unmanned aerial vehicle;
connecting the second battery to the unmanned aerial vehicle; and
releasing the battery carrier from the second battery.
